(19) United States
(12) Patent Application Publication
(10) Pub. No.: US 2021/0090153 A1
(43) Pub. Date: Mar. 25, 2021

(54) BATTERY MANAGEMENT APPARATUS

(71) Applicant: Honda Motor Co., Ltd., Tokyo (JP)

(72) Inventors: Yu Murai, Wako-shi (JP); Satoshi Onodera, Tokyo (JP); Masahiro Ise, Wako-shi (JP); Hiroya Okuda, Tokyo (JP); Tsubasa Uchida, Wako-shi (JP); Yukiko Onoue, Wako-shi (JP); Yuki Morita, Tokyo (JP); Masako Komaki, Wako-shi (JP); Masato Naito, Nagoya-shi (JP)

(21) Appl. No.: 17/029,004

(22) Filed: Sep. 22, 2020

(30) Foreign Application Priority Data
Sep. 24, 2019 (JP) 2019-172497

(51) Int. Cl. G06Q 30/06

(52) U.S. Cl. CPC G06Q 30/0631; H02J 7/005

(57) ABSTRACT

A battery management apparatus including a microprocessor configured to perform acquiring a battery information on batteries, acquiring a battery requirement information required by a user, and extracting a candidate battery satisfying the battery requirement as a candidate for a presentation battery from among the batteries based on the battery information and the battery requirement information. The battery information includes a battery element information on each of battery elements included in a first battery and a second battery, and the microprocessor is configured to perform the extracting including determining whether it is possible to constitute the candidate battery by a combination battery including the battery elements included in the first battery and the second battery, and when it is determined that it is possible to constitute the candidate battery by the combination battery, extracting the combination battery as the candidate battery.

### CROSS-REFERENCE TO RELATED APPLICATION

This application is based upon and claims the benefit of priority from Japanese Patent Application No. 2019-172497 filed on Sep. 24, 2019, the content of which is incorporated herein by reference.

### BACKGROUND OF THE INVENTION

### Field of the Invention

This invention relates to a battery management apparatus configured to manage a battery reused through a distribution in a market.

### Description of the Related Art

Conventionally, there is a known apparatus configured to select a battery having a desired performance satisfying a user request from among a plurality of used batteries, and present the selected battery to a user who wants to replace the battery mounted on an electric vehicle. Such an apparatus is described, for example, in Japanese Unexamined Patent Publication No. 2013-084198 (JP2013-084198A). In the apparatus described in JP2013-084198A, prior to battery replacement, the degree of deterioration of the used battery after the battery has been replaced is predicted in advance, candidates for the used battery having the desired performance are extracted based on the degree of deterioration, and among the extracted candidates, the used battery to be presented to the user is selected.

A battery mounted on a vehicle, for example, an electric vehicle is generally configured by connecting a plurality of battery elements such as cells or modules in series and or in parallel. In the apparatus described in JP2013-084198A, whether or not a used battery having the desired performance is determined for each battery. Therefore, when there is a used battery having the desired performance on a battery element basis but not on a battery basis, the used battery is excluded from candidates of used batteries to be extracted. As a result, there is a risk that the number of candidates for used batteries will be reduced and the user will not be able to present the optimal used battery.

### SUMMARY OF THE INVENTION

An aspect of the present invention is a battery management apparatus configured to manage a plurality of batteries including a used battery, including an electronic control unit including a microprocessor and a memory connected to the microprocessor. The microprocessor is configured to perform: acquiring an information on the plurality of batteries as a battery information; acquiring a battery requirement information including a battery requirement required by a user; and extracting a candidate battery satisfying the battery requirement as a candidate for a presentation battery to be presented to the user from among the plurality of batteries, based on the battery information and the battery requirement information. The plurality of batteries include a first battery and a second battery, the battery information includes a battery element information on each of a plurality of battery elements included in the first battery and a battery element information on each of a plurality of battery elements included in the second battery, and the microprocessor is configured to perform the extracting including determining whether it is possible to constitute the candidate battery satisfying the battery requirement by a combination battery including a part of the plurality of battery elements included in the first battery and a part of the plurality of battery elements included in the second battery, and when it is determined that it is possible to constitute the candidate battery by the combination battery, extracting the combination battery as the candidate battery.

### BRIEF DESCRIPTION OF THE DRAWINGS

The objects, features, and advantages of the present invention will become clearer from the following description of embodiments in relation to the attached drawings, in which:

FIG. 1 is a diagram schematically showing a configuration of main components of a travel drive system of a motor-driven vehicle to which a battery management apparatus according to an embodiment of the invention is applied;

FIG. 2 is a diagram showing an example of temporal changes in SOH of a battery;

FIG. 3 is a block diagram schematically showing an overall configuration of a battery management system including the battery management apparatus according to the embodiment of the present invention;

FIG. 4 is a diagram schematically showing an example of candidate batteries extracted by the battery management apparatus according to the embodiment of the invention; and

FIG. 5 is a flowchart showing an example of a process performed by a CPU of a server device of FIG. 3.

### DETAILED DESCRIPTION OF THE INVENTION

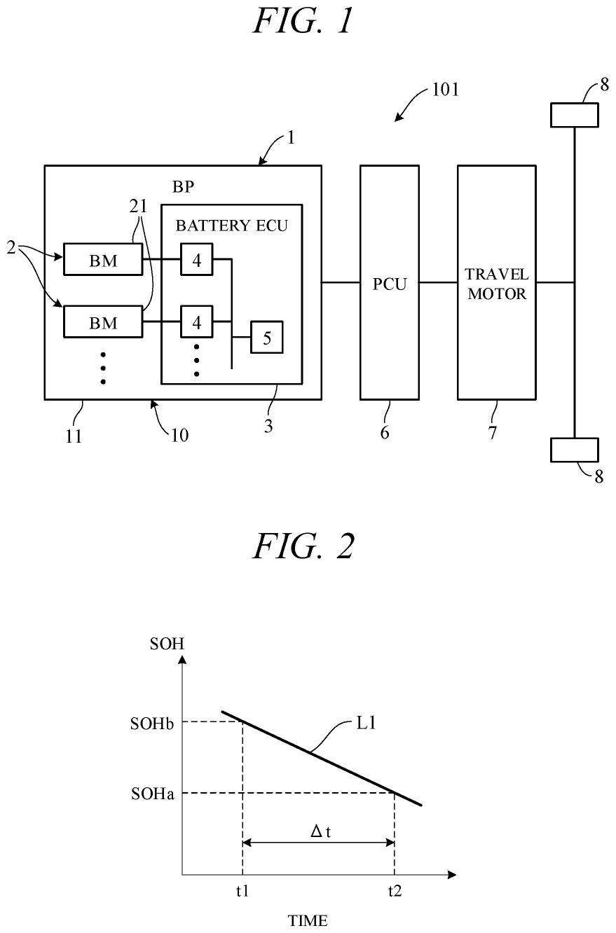

Hereafter, an embodiment of the present invention is explained with reference to FIGS. 1 to 5. A battery management apparatus according to the embodiment of the present invention is configured to manage used batteries (secondary batteries) that are circulated in the market and reused. Used batteries can be obtained at lower cost than new batteries and therefore there are high user needs for them. Also, reuse of batteries greatly contributes to the environment. Such used batteries can be used in various fields and applications, such as vehicles and houses. Hereafter, an example of a battery management apparatus applied to a battery used in a vehicle including a travel motor, such as an electric vehicle or hybrid vehicle, will be described.

FIG. 1 is a diagram schematically showing the configuration of main components of the travel drive system of a motor-driven vehicle 101 (may be simply referred to as the vehicle) to which the battery management apparatus according to the present embodiment is applied. As shown in FIG. 1, the vehicle 101 includes a battery 10, a power control unit (PCU) 6, and a travel motor 7.

The battery 10 is configured as a unit by a single battery pack (BP) 1. The battery 10 may be configured by multiple battery packs 1. If the battery 10 is configured by the single battery pack 1 as seen in the present embodiment, the battery 10 and battery pack 1 are the same. For this reason, the battery pack 1 may be hereafter referred to as the battery 10.

The battery pack 1 includes multiple battery modules (BM) 2 and a battery ECU (Electronic Control Unit) 3. The battery modules 2 each include an approximately rectangular parallelepiped housing 21 and multiple cells that are stacked in the housing 21. The battery modules 2 are in the same shape, for example. The cells are, for example, flat lithium-ion cells sealed by a laminate film and are housed in the sealed housing 21 so as to be connected in series or in parallel, forming a lithium-ion battery.

The battery modules 2 are connected in series or in parallel through a bus bar or the like so that a predetermined voltage or capacity is obtained from the combination of the battery modules. The battery pack 1 includes a battery case 11. The battery case 11 includes, for example a pair of upper and lower case portions fastened by a bolt and houses the battery modules 2. The battery case 11 is formed so as to be approximately rectangular in plan view, for example, and low in height and disposed on the bottom or the like of the vehicle 101. While the single battery pack 1 is disposed in the battery case 11 in FIG. 1, multiple battery packs 1 connected in series or in parallel in the battery case 11 may form the battery 10.

The battery ECU 3 includes multiple detection circuits 4 that detect the states of the battery modules 2 (module states) and a detection circuit 5 that detects the state of the battery pack 1 (pack state). For example, the detection circuits 4 each include sensors that detect the physical quantities, such as the current, voltage, and temperature, of the corresponding battery module 2 and calculate the state of charge (SOC) and the state of health (SOH) of the battery modules 2 as the module states on the basis of the detected physical quantities. The detection circuit 5 calculates the SOC and SOH of the entire battery as the pack state on the basis of signals from the detection circuits 4.

The SOH is a value representing the degree of degradation of the battery 10. The SOH is defined as the retention ratio of the battery capacity reduced with time with respect to the battery performance when the battery was new (=capacity at certain time/initial capacity). Hereafter, the performance of the battery 10 is represented by the SOH for convenience. The battery 10 is healthier as its SOH is higher. The SOH may be defined as the increase rate of the internal resistance (resistance value at certain time/initial resistance value) rather than the capacity retention ratio.

When the SOH becomes equal to or smaller than a predetermined lower-limit value SOHa, the cruising range travelable by charging the battery once becomes equal to or smaller than a reference value or other problems occur. Accordingly, the battery needs to be replaced. The SOH varies with the use state (charge time, discharge time, the amount of change, the amount of discharge, etc.) or use environment (temperature, etc.) of the battery 10. When replacing the battery 10 with a used battery, the SOH of the used battery 10 is required to be equal to or greater than the predetermined value (required value) SOHb at the time of replacement.

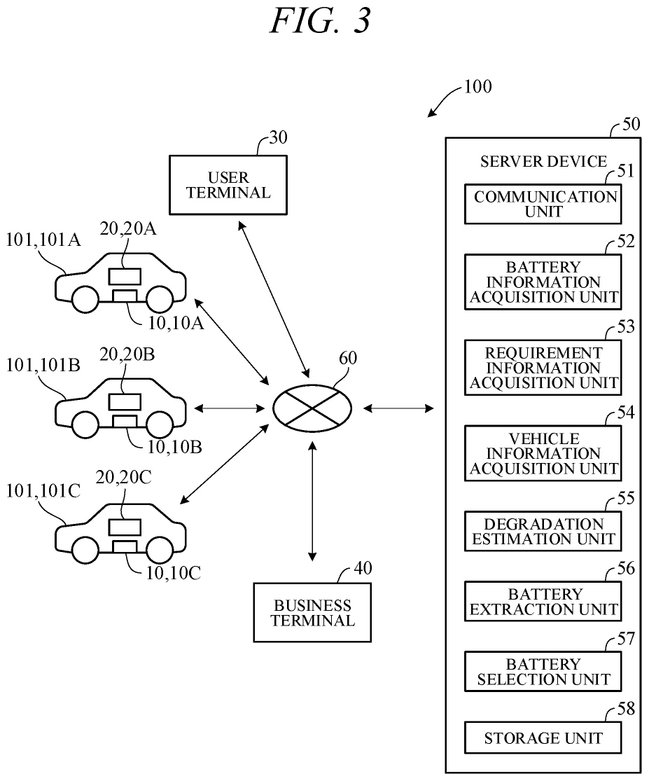

FIG. 2 is a diagram showing an example of temporal changes in the SOH of the battery 10. As shown in FIG. 2, it is assumed that the SOH decreases to the lower-limit value SOHa along a characteristic L1 over a predetermined time period Δt (desired use time period) from the initial time t1, at which the battery has been replaced, to the end time t2. To use the used battery 10 over the predetermined time period Δt, the SOH of the used battery 10 must be equal to or greater than a predetermined value at the initial time t1. This predetermined value corresponds to the required value SOHb. The characteristic L1 depends on the use state or use environment of the battery 10.

The battery ECU 3 calculates the SOH of the battery modules 2 and the SOH of the battery pack 1 using the current, voltage, and temperature obtained by the detection circuits 4 and 5 and the elapsed time as parameters and using a known battery model. Instead of calculating the SOH using the battery model, the SOH may be calculated by obtaining temporal changes in the voltage during a charge (charge characteristic), changes in the voltage corresponding to changes in the discharge capacity (discharge load characteristic), changes in the battery capacity corresponding to changes in the charge and discharge frequency (charge and discharge cycle characteristic), and the like and then comparing these characteristics with predetermined reference characteristics corresponding to these characteristics, that is, characteristics obtained from a standard battery 10. The value of the SOH required when replacing the battery, i.e., a required value SOHb can be calculated by a vehicle terminal 20 (FIG. 3) of the vehicle 101 considering the use state or use environment of the battery 10.

The battery 10 supplies power to the power control unit (PCU) 6 through a junction box (not shown) mounted on the battery case 11. The power control unit 6 includes an inverter circuit. The power control unit 6 converts the direct current from the battery 10 into alternating current using the inverter circuit and supplies the drive power to the travel motor 7. Thus, the travel motor 7 is driven, drive wheels 8 are rotationally driven, and the vehicle 101 travels.

FIG. 3 is a block diagram schematically showing the overall configuration of a battery management system 100 including the battery management apparatus according to the present embodiment. As shown in FIG. 3, the battery management system 100 includes vehicle terminals 20 (20A to 20C) of multiple vehicles 101 (101A to 101C) previously registered with the battery management system 100, a user terminal 30 owned by a user who wants to replace the battery, a terminal 40 of a business office that performs operations relating to battery replacement (business terminal), and a server device 50. The server device 50 mainly constitutes the battery management apparatus according to the present embodiment.

The vehicles 101 include the vehicle (hereafter referred to as “subject vehicle”) 101A owned by a user who wants to replace the battery at a predetermined time in the future (a user who owns the user terminal 30) and the other vehicles 101B and 101C. The vehicles 101 have batteries 10 (10A to 10C) mounted thereon. The other vehicles 101B and 101C are vehicles on which the batteries 10B and 10C replaceable at the predetermined time in the future are mounted, for example, vehicles from which the batteries 10B and 10C are scheduled to be demounted for some reason at latest before the predetermined time. In other words, the other vehicles 101B and 101C are vehicles including the reusable batteries 10B and 10C. For example, the vehicles 101A to 101C are of the same or similar type.

Accordingly, the batteries 10A to 10C of the vehicles 101A to 101C have the same configuration. When replacing the battery of the subject vehicle 101A, the batteries 10B and 10C mounted on the other vehicles 101B and 101C can serve as candidate batteries for replacement. The other vehicles 101B and 101C only need to include the batteries 10B and 10C (other-vehicle batteries) that are of the same or similar type to the battery 10A of the subject vehicle 101A (subject-vehicle battery) and need not be of the same or similar vehicle type. The same or similar type of batteries that serve as candidates when replacing the battery (hereafter referred to as “candidate batteries”) refer to two types (first and second types) of candidate batteries 110, that is, a first candidate battery 111 and a second candidate battery 112, as described below.

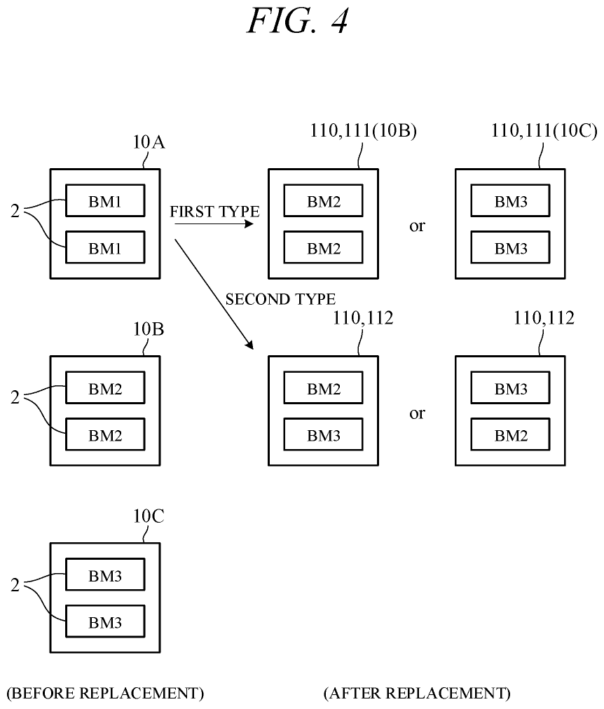

FIG. 4 is a diagram schematically showing an example of the candidate batteries 110 (111, 112). To avoid complication, it is assumed in FIG. 4 that the yet-to-be-replaced batteries 10A to 10C of the vehicles 101 are configured by a single battery pack 1 including two battery modules (BM1, BM1), (BM2, BM2) and (BM3, BM3), respectively.

If the other-vehicle battery 10B or 10C is configured by a battery pack 1 whose specification (shape, initial performance, etc.) is the same or similar to that of the subject-vehicle battery 10A, that is, configured by battery modules (BM2, BM2) or (BM3, BM3) whose specification is the same or similar to that of the battery modules (BM1, BM1) of the subject-vehicle battery 10A as shown in FIG. 4, has SOH (the SOH of the battery pack 1) at the time of battery replacement equal to or greater than the required value SOHb, and also has the price and the like satisfying the user requirements, the battery 10B or 10C serves as a first candidate battery 111. In this case, battery replacement can be performed by dissembling the battery case 11 and replacing the battery pack 1 inside the battery. Battery replacement may be performed by replacing the entire battery including the battery case 11 without dissembling the battery case 11.

If the specification of parts of the battery packs 1 of the other batteries 10B and 10C is the same or similar to specification of parts of the battery pack 1 of the subject-vehicle battery 10A, that is, the specification (shape, initial performance, etc.) of certain battery modules 2 of the batteries 10B and 10C is the same or similar to that of the battery modules 2 of the subject-vehicle battery 10A, and a battery pack (combination battery) 1 formed by combining the battery modules 2 having such specification of the batteries 10B and 10C has SOH (the SOH of the battery pack 1) at the time of battery replacement equal to or greater than the required value SOHb and also has the price and the like satisfying the user requirements, this combined battery serves as a second candidate battery 112.

For example, a combination battery obtained by combining the battery module (BM2) of the battery 10B and the battery module (BM3) of the battery 10C serves as a second candidate battery 112. Whether the SOH of the combination battery is equal to or greater than the required value SOHb may be determined in accordance with the magnitude of the SOH of the respective battery modules 2 forming the combination battery. For example, if the combination battery 112 is formed by combining only the battery modules 2 whose SOH is equal to or greater than SOHb, it is determined that the SOH of the combination battery 112 is equal to or greater than the required value SOHb. While the first candidate battery 111 is configured by the battery modules 2 of the single battery 10 (10B or 10C), the second candidate battery (combination battery) 112 is configured by the battery modules 2 of the multiple batteries 10 (10B and 10C).

As shown in FIG. 3, the vehicle terminals 20, user terminal 30, business terminal 40, and server device 50 are connected to a network 60, such as a public wireless communication network typified by the Internet network or mobile telephone network, and are able to communicate with each other through the network 60. Examples of the network 60 also include closed communication networks provided for predetermined control areas, for example, wireless LANs, Wi-Fi (registered trademark), and the like.

Each vehicle terminal 20 includes, as functional configurations, a communication unit that makes communications through the network 60 and a controller that serves as the control unit of the vehicle 101. The vehicle terminal 20 transmits information about the vehicle 101 on which the battery 10 is mounted (vehicle information) and information about the battery 10 obtained from various types of sensors and ECUs mounted on the vehicle 101 (battery information) to the server device 50 through the communication unit along with a vehicle ID for identifying the vehicle 101 and a battery ID for identifying the battery 10 at a predetermined timing.

The battery information includes information indicating the SOH of the battery modules 2 and the SOH of the battery pack 1 calculated by the battery ECU 3. The vehicle terminal 20 transmits the information indicating the SOH to the server device 50 along with battery module IDs for identifying the battery modules 2 and a battery pack ID for identifying the battery pack 1. The battery information also includes information about failures and repairs of the battery 10 in the past (details, times, etc.) and information about replacement of the battery 10 in the past (the reasons for replacement, the times of replacement, etc.).

The vehicle information includes information indicating the ID of the battery 10 mounted on the vehicle 101 (battery ID), information indicating the vehicle type, model year, registered address, and the like of the vehicle 101, as well as information indicating the travel environment or travel state of the vehicle 101 obtained from the vehicle-mounted sensors, that is, information indicating the travel distance, travel time, stop time, average acceleration or deceleration speed, temperature environment, and the like. When replacing the battery 10 of the vehicle 101, the place in which the battery is replaced (e.g., the nearest business office, etc.) must be determined. For this reason, the vehicle terminal 20 may detect the location of the vehicle 101 using a GPS sensor or the like and transmit information indicating the location as a part of the vehicle information along with the battery information through the communication unit.

The user terminal 30 is configured by a mobile terminal, such as a smartphone, tablet terminal, mobile phone, or wearable terminal, carried and used by the user. The user terminal 30 includes, as functional configurations, a communication unit that makes communications through the network 60, an input unit that inputs commands, a display that displays various types of information, a controller that controls the elements of the user terminal 30, and the like.

When the user who wants to replace the battery inputs battery requirement information (referred to as “user requirement information”) through the input unit of the user terminal 30, the user requirement information is transmitted to the server device 50 through the communication unit along with a user ID for identifying the user. The user requirement information includes information indicating the ID of the vehicle 101 (101A) owned by the user (vehicle ID), as well as information indicating the timing when the user wants to replace the battery (the time, travel distance, etc.), the desired purchase price of the battery 10 (the upper-limit price, maximum price, etc.), the grade of the battery 10 (the level of quality), the expected years of use of the battery 10, and the like. The control unit of the vehicle 101 may be configured to determine whether the battery need to be replaced and to notify the user of the determination through the communication unit of the user terminal 30. The expected years of use of the battery 10 need not be inputted by the user but rather a specified value previously set on the vehicle terminal 20 may be used as the expected years of use.

Battery requirement information is transmitted not only from the user terminal 30 but also from the vehicle terminal 20. This battery requirement information is referred to as “vehicle requirement information” so that it is distinguished from the user requirement information. For example, when the user terminal 30 transmits the user requirement information, the vehicle terminal 20 transmits the battery requirement information including a predetermined battery performance required by the user (vehicle requirement information) to the server device 50 along with the vehicle ID. The vehicle requirement information includes information indicating the cruising range of the subject vehicle 101 (101A) obtained by charging the battery once, the capacity of the battery 10 (the battery capacity required by the subject vehicle 101A), the environment in which the battery 10 is used (the upper and lower limits of the temperature, etc.), the frequency of charge, and the like. The vehicle requirement information can be obtained from information obtained by the sensors and ECUs disposed on the vehicle 101. That is, the control unit of the vehicle 101 can estimate the vehicle requirement information on the basis of the travel state of the vehicle 101 and the use state of the battery 10 (cruising range, temperature, the frequency of charge, etc.). The user may specify a part (e.g., the cruising range) of the vehicle requirement information through the user terminal 30.

The battery requirement information also includes information indicating the required value SOHb that the replacement battery 10 should satisfy at the time of battery replacement. The required value SOHb is calculated by, for example, the vehicle terminal 20 (20A) on the basis of the use environment or use state of the yet-to-be replaced battery 10 (10A). Specifically, the vehicle terminal 20 receives information indicating the expected years of use transmitted from the user terminal 30 and calculates the required value SOHb that allows for use of the battery 10 over the expected years of use. The vehicle terminal 20 then transmits the calculated required value SOHb to the server device 50 as a part of the battery requirement information. If a specified value is used as the expected years of use of the replacement battery, the vehicle terminal 20 may calculate the required value SOHb without communicating with the user terminal 30. Instead of the vehicle terminal 20, the server device 50 may calculate the required value SOHb.

The business terminal 40 includes, as a functional configuration, a communication unit that makes communications through the network 60. The business terminal 40 transmits information about various types of batteries managed by the business office to the server device 50 through the communication unit along with the battery IDs. Battery information transmitted from the business terminal 40 includes the information about the batteries 10 managed by the business office, as well as information indicating the storage period of the batteries 10, information indicating the schedule of receipt of the batteries 10 into the business office, information indicating the schedule of take-out of the batteries 10 from the business office, and the like.

The server device 50 is formed, for example, as a single server or as distributed servers consisting of servers having different functions. The server device 50 may be formed as distributed virtual servers created in the cloud environment, which are called cloud servers. The server device 50 includes an arithmetic processing unit including a CPU (microprocessor), memory such as ROM or RAM, and other peripheral circuits.

The server device 50 includes, as functional configurations, a communication unit 51, a battery information acquisition unit 52, a requirement information acquisition unit 53, a vehicle information acquisition unit 54, a degradation estimation unit 55, a battery extraction unit 56, a battery selection unit 57, and a storage unit 58. The CPU serves as the battery information acquisition unit 52, requirement information acquisition unit 53, vehicle information acquisition unit 54, degradation estimation unit 55, battery extraction unit 56, and battery selection unit 57.

The communication unit 51 is configured to be able to wirelessly communicate with the vehicle terminals 20, user terminal 30, and business terminal 40 through the network 60. The communication unit 51 receives and transmits various types of information from and to the vehicle terminals 20, user terminal 30, and business terminal 40 in a predetermined cycle or at a predetermined timing.

The battery information acquisition unit 52 acquires information about the multiple batteries 10 (10A to 10C) (battery information) from the vehicle terminals 20 and business terminal 40 along with the battery IDs. The battery information includes information indicating the performance of each battery 10, that is, information indicating the SOH of the battery pack 1 and battery modules 2 of each battery 10 (SOH information). The SOH information is stored in the storage unit 58 so as to be associated with the battery pack ID and battery module IDs.

The requirement information acquisition unit 53 acquires battery requirement information from the vehicle terminal 20 (20A) and user terminal 30 along with the vehicle ID and user ID. The acquired battery requirement information includes the user requirement information including the scheduled battery replacement time and the desired purchase price of the battery 10 and the information indicating battery performance that the replacement battery 10 is required to have (the required value SOHb, etc.). The acquired battery requirement information is stored in the storage unit 58 so as to be associated with the vehicle ID and user ID.

The vehicle information acquisition unit 54 acquires the vehicle information from the vehicle terminals 20 (20A to 20C) of the vehicles 101 (101A to 101C). The acquired vehicle information is stored in the storage unit 58 so as to be associated with the vehicle IDs. The battery IDs (battery pack IDs, battery module IDs), user IDs, and vehicle IDs are stored in the storage unit 58 so as to be associated with each other. Thus, the vehicles 101A to 101C, the users of the vehicles 101A to 101C, and the batteries 10A to 10C mounted on the vehicles 101A to 101C are associated with each other.

The degradation estimation unit 55 predicts the SOH of each battery 10 at the scheduled time of battery replacement on the basis of the battery information and vehicle information stored in the storage unit 58. For example, the degradation estimation unit 55 calculates the change rate of the SOH of each battery 10 (10A to 10C) from temporal changes in the SOH of the battery 10 from the past to the present time (changes as shown by the characteristic L1 in FIG. 2) and predicts the SOH of each battery 10 at the scheduled future time of battery replacement using this change rate. More specifically, the degradation estimation unit 55 predicts the SOH of each battery 10 at the scheduled future time of replacement of the battery 10 (e.g., at the time after three months) on the basis of the change rate of the SOH of each battery 10 over the past one year.

The battery extraction unit 56 extracts the batteries satisfying battery requirements set by the user, that is, candidate batteries 110 from among multiple used batteries 10 (battery packs 1, battery modules 2), for example, the other-vehicle batteries 10B and 10C on the basis of the battery information, vehicle information, and battery requirement information (e.g., user requirement information) stored in the storage unit 58. In this case, the battery extraction unit 56 extracts candidate batteries 110 from among the batteries whose SOH at the scheduled future time of replacement is equal to or greater than the required value SOHb, estimated by the degradation estimation unit 55.

More specifically, the battery extraction unit 56 first determines whether there is a battery pack 1 whose specification is the same or similar to that of the subject-vehicle battery 10A and whose SOH is equal to or greater than the required value SOHb. If it determines that there is a battery pack 1 satisfying those requirements and also satisfying the other battery requirements (price, etc.) set by the user, the battery extraction unit 56 extracts a battery 10 (10B or 10C) including this battery pack 1 as a first candidate battery 111.

On the other hand, if it determines that there is no such battery pack 1, the battery extraction unit 56 determines whether the battery requirements can be satisfied by combining multiple battery modules 2 whose specification is the same or similar to that of the subject-vehicle battery 10A. That is, the battery extraction unit 56 determines whether, among battery packs 1 formed by combining multiple battery modules 2 having different vehicle IDs, there are ones whose SOH is equal to or greater than the required value SOHb. If it determines that there are battery modules 2 satisfying this requirement and those battery modules 2 satisfy the other battery requirements (price, etc.) set by the user, the battery extraction unit 56 extracts multiple batteries 10 (10B and 10C) including those battery modules 2 as second candidate batteries 112. Information about the candidate battery(ies) 110 extracted by the battery extraction unit 56 is stored in the storage unit 58 along with the battery ID(s) (battery pack ID, battery module IDs).

The battery selection unit 57 selects a presentation battery to be presented to the user from among the candidate battery(ies) 110 stored in the storage unit 58. For example, if there are multiple candidate batteries 110, the battery selection unit 57 selects a presentation battery in accordance with a predetermined criterion. For example, the predetermined criterion is one of whether the battery is lowest in price, whether the battery is best in performance, and whether the battery is nearest.

Information about the presentation battery selected by the battery selection unit 57 is stored in the storage unit 58 along with the battery ID (battery pack ID, battery module IDs) of the battery, as well as is transmitted to the user terminal 30 and business terminal 40 through the communication unit 51. Thus, use of the used battery 10 forming the presentation battery at the desired time of replacement is reserved. The user is able to recognize the cost required to replace the battery, the performance of the replacement battery, and the like, and the business office is able to grasp the battery replacement schedule. The presentation battery stored in the storage unit 58, that is, the used battery 10 whose use has been reserved will be hereafter excluded from candidate replacement batteries 110 that may be used to replace the battery.

The battery selection unit 57 may select multiple presentation batteries from among multiple candidate batteries 110 and transmit information indicating the presentation batteries to the user terminal 30 so that the user selects one of the presentation batteries by operating the user terminal 30. In this case, the battery selection unit 57 may assign priorities to the presentation batteries and transmit such presentation batteries to the user terminal 30. This allows the user to easily select among the presentation batteries.

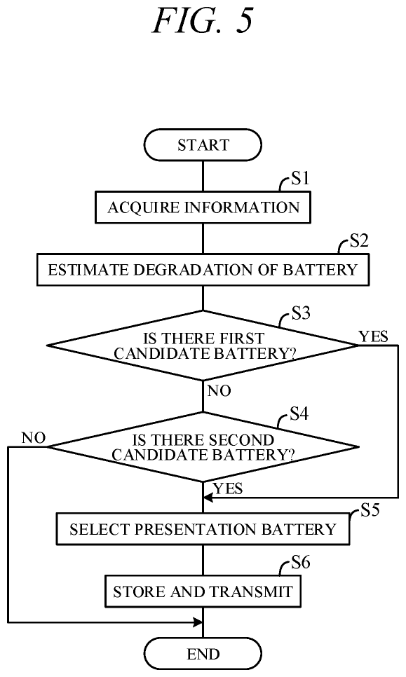

FIG. 5 is a flowchart showing an example of a process performed by the CPU of the server device 50 in accordance with a predetermined program. The process shown in this flowchart is mainly performed by the battery information acquisition unit 52, requirement information acquisition unit 53, vehicle information acquisition unit 54, degradation estimation unit 55, battery extraction unit 56, and battery selection unit 57. This process is started, for example, when the server device 50 receives a battery replacement requirement from the user terminal 30.

First, in S1 (S: processing step), the server device 50 (CPU) acquires information on multiple used batteries 10 (battery information), battery requirement information (e.g., user requirement information), and vehicle information and stores the acquired information in the storage unit 58. Then, in S2, the server device 50 (CPU) calculates an estimation value of the SOH of each of the used batteries 10 at the scheduled future time of battery replacement on the basis of the battery information and vehicle information acquired in S1.

Then, in S3, the server device 50 (CPU) determines whether there is a first candidate battery 111 among the used batteries 10 (10B, 10C), on the basis of the information acquired in S1 and the SOH at the time of battery replacement estimated in S2. That is, the server device 50 determines whether there is a used battery 10 satisfying the battery requirements set by the user. If the determination in S3 is NO, the processing proceeds to S4, while if the determination in S3 is YES, the processing proceeds to S5.

In S4, the server device 50 (CPU) determines whether there are second candidate batteries 112 among the used batteries 10 (10B, 10C), on the basis of the information estimated in S1 and the SOH at the time of battery replacement estimated in S2. That is, the server device 50 determines whether there are combinations of the battery modules 2 of the used batteries that satisfy the battery requirements set by the user. If the determination in S4 is YES, the processing proceeds to S5, while if the determination in S4 is NO, the processing ends. When the determination in S4 is NO, the server device 50 may end the processing by transmitting a notification that there is no candidate battery 110, to the user terminal 30.

In S5, the server device 50 (CPU) selects a presentation battery to be presented to the user from among the candidate battery(ies) 110 (first candidate battery 111, second candidate batteries 112) extracted in S3 or S4 in accordance with the predetermined criterion. If a single candidate battery 110 is extracted in S3 or if a single candidate battery 110 configured by a combination of the battery modules 2 is extracted in S4, the server device 50 selects, in S5, the candidate battery 110 as a presentation battery as it is.

Then, in S6, the server device 50 (memory) stores information on the presentation battery selected in S5 in the storage unit 58 along with the battery ID. The server device 50 also transmits the information on the presentation battery to the user terminal 30 and business terminal 40, ending the processing.

Operation of the battery management apparatus according to the present embodiment can be summarized as follows. When the user instructs a replacement request of the subject-vehicle battery 10A through the user terminal 30, candidate batteries 110 that may serve as a replacement at the scheduled time of battery replacement are extracted, for example, from among the multiple used batteries 10B and 10C shown in FIG. 4, by the battery management apparatus (server device 50). In this case, firstly, it is determined whether the used batteries 10B and 10C each including the battery pack 1 having the same specification as that of the subject-vehicle battery 10A satisfy the predetermined requirements (required value SOHb, price, etc.) included in the battery requirement information from the user (S3). If it is determined that both the used batteries 10B and 10C satisfy the predetermined requirements, the used batteries 10B and 10C are served as candidate batteries 110 (first candidate batteries 111). Then, one of the used batteries 10B and 10C is selected as a presentation battery, and information on the presentation battery is notified to the user through the user terminal 30 (S5, S6). Thus, it is possible to replace the subject-vehicle battery 10A (battery pack 1) with the used battery 10B or 10C (battery pack 1) satisfying the desired requirements at the time of battery replacement.

On the other hand, if it is determined that the used batteries 10B and 10C do not satisfy the predetermined requirements included in the battery requirement information, it is determined whether the combination battery 112 obtained by combining the battery modules (BM2, BM3) of the multiple different batteries 10B and 10C satisfies the predetermined requirements by the server device 50 (S4). If it is determined that the combination battery 112 satisfies the predetermined requirements, both the used batteries 10B and 10C are served as candidate batteries 110 (second candidate batteries 112), and information on the presentation battery configured by these second candidate batteries 112 is notified to the user through the user terminal 30 (S5, S6). As seen above, formation of the battery packs 1 by combining the battery modules (BM2, BM3) of the different batteries 10B and 10C allows for expansion of the range of the candidate batteries 110.

For example, assume that there is a variation in the performance of the multiple battery modules (BM2) forming the battery 10B, that is, the SOH of one battery module 2 is equal to or greater than the required value SOHb but the SOH of the remaining battery module 2 is smaller than the required value SOHb and thus the SOH of the battery pack 1 is smaller than the required value SOHb. In this case, conventionally, the entire battery 10B is excluded from the candidate batteries 110. This prevents effective use of the battery module 2 whose SOH is equal to or greater than the required value SOHb, leading to inefficiency. On the other hand, the present embodiment allows for effective use of the battery module 2 whose SOH is equal to or greater than the required value SOHb and thus allows for efficient reuse of the used battery 10. As a result, the present embodiment is able to expand the range of the candidate batteries 110 and to present, to the user, the most suitable used battery (combination battery 112) satisfying the predetermined requirements.

If the prices of the used battery packs 1 do not satisfy the user requirement but the price of a battery pack 1 formed as a combination battery satisfies the user requirement, used batteries forming the combination battery serve as second candidate batteries 112. This case also means expansion of the range of the candidate batteries 110 and allows for presentation of the most suitable used battery to the user.

The present embodiment can achieve advantages and effects such as the following:

(1) A server device 50 served as a battery management apparatus is configured to manage used batteries 10A to 10C including multiple battery modules 2 connected in series or parallel. The server device 50 includes a battery information acquisition unit 52 acquiring an information (battery information) on the multiple used batteries 10A to 10C; a requirement information acquisition unit 53 acquiring a battery requirement information including a predetermined requirement (battery requirement) such as a required value SOHb for the used batteries 10B and 10C by a user (user of the vehicle 101A) having a plan of using the used batteries 10B and 10C and a desired price for purchase; and a battery extraction unit 56 extracting a candidate battery 110 satisfying the battery requirement as a candidate for a presentation battery to be presented to the user from among the multiple used batteries 10B and 10C, based on the battery information acquired by the battery information acquisition unit 52 and the battery requirement information acquired by the requirement information acquisition unit 53 (FIG. 3). The battery information acquired by the battery information acquisition unit 52 includes information on a SOH of each of the multiple battery modules 2. The battery extraction unit 56 determines whether it is possible to constitute the candidate battery 110 satisfying the battery requirement by a combination battery 112 obtained by a combination of the battery modules (BM2 and BM3) included in the different used batteries 10B and 10C, based on the information on each of the multiple battery modules 2 acquired by the battery information acquisition unit 52, and if the battery extraction unit 56 determines that it is possible to constitute the candidate battery 110, it extracts the combination battery 112 as the candidate battery 110 (FIG. 5).

Thus, by configuring the candidate battery 110 in units of the battery elements (battery modules 2) constituting the multiple used batteries 10B and 10C, the number of candidates of the used battery to be used for battery replacement increases. Therefore, it is possible to provide an optimum used battery that satisfies the user's requirements.

(2) The battery extraction unit 56 determines whether there is a first candidate battery 111 satisfying the predetermined battery requirement by used battery itself among the multiple used batteries 10B and 10C (S3), and if it is determined that there is not the first candidate battery 111, it determines whether it is possible to constitute the candidate battery 110 by the combination battery 112 configured by the multiple battery modules (BM2 and BM3) included in the used batteries 10B and 10C different from each other (S4). Thus, since the first candidate battery 111 is the presentation battery preferentially, it is easy to replace the battery. That is, since the first candidate battery 111 can be replaced per battery pack 1, the battery replacement is easier than when using the combination battery 112.

(3) The server device 50 further includes a degradation estimation unit 55 estimating a SOH of each of the multiple used batteries 10B and 10C at a predetermined time in a future (FIG. 3). The battery extraction unit 56 extracts the candidate battery 110 from among the multiple used batteries 10B and 10C, based on the SOH estimated by the degradation estimation unit 55. As a result, it is possible to extract the used battery 10 satisfying the predetermined requirement at a predetermined time in advance, and it is possible to start preparation for battery replacement at an early stage.

(4) The server device 50 includes a battery selection unit 57 selecting the presentation battery for presenting to the user from among the candidate batteries 110 extracted by the battery extraction unit 56 before the scheduled battery replacement time, and a storage unit 58 memorizing an information on the presentation battery selected by the battery selection unit 57 (FIG. 3). Thus, since the presented battery is reserved in advance, the battery replacement can be efficiently performed without a situation such as when there is no inventory of the used battery 10 at the time of battery replacement. In addition, not only the used battery 10 stored in the business office in advance, but also the batteries 10B and 10C mounted in the vehicles 101B and 101C in use become the candidate battery 110, so that the storage period of the battery at the business office can be shortened. Therefore, it is possible to efficiently distribute the reused used battery 10 in the market.

Various modifications of the above embodiment are possible. Some examples are explained in the following. Although in the above embodiment, the battery module 2 is used as a battery element, and a plurality of battery modules 2 included in the used battery 10 that are different from each other are combined to constitute the combination battery 112. However, when the battery 10 is configured by a plurality of battery packs 1, the battery pack 1 may be used as a battery element, and a plurality of battery packs 1 included in the used battery 10 that are different from each other may be combined to constitute the combination battery. If the configurations of the battery cases 11 of the subject-vehicle battery 10A and the candidate battery 110 are the same as each other, the battery case 11 may be replaced at the time of battery replacement.

In the above embodiment, the fact that the SOH of the used battery 10 at the scheduled time of battery replacement is equal to or greater than a predetermined value (required value SOHb) is included in the battery requirement included in the battery requirement information, but the battery requirement is not limited this. For example, it may be included in the battery requirement that a grade of the used battery 10 is a predetermined value or more. The grade is high, for example, when there is no history of battery failure or repair, and when there is no variation in the SOH between multiple battery modules included in the used battery 10. The grade has a correlation with the price of the used battery 10, and a user who wants to suppress the price sets the grade of the candidate battery 110 low. Thus, it is possible to satisfy the requirements of various users.

In the above embodiment, the battery extraction unit 56 determines whether or not the candidate battery 110 can be configured by the combination battery 112 constituted by combining the battery element of the battery 10B (first battery) mounted on the other vehicle 101B (first vehicle) and the battery element of the battery 10C (second battery) mounted on the other vehicle 101C (second vehicle), but the configuration of a battery extraction unit is not limited to this. In the above embodiment, used battery 10 satisfying the battery requirement is presented to the user of the vehicle 101 from among the plurality of used batteries 10. However, the object to which the battery managed by a battery management apparatus is applied is not limited to the vehicle 101. For example, the battery 10 of the vehicle may be used as a battery of the house, and the object may be the house.

The present invention can be configured as a battery management method configured to manage a plurality of batteries including a used battery 10, including: acquiring an information on the plurality of batteries 10A to 10C as a battery information; acquiring a battery requirement information including a battery requirement required by a user; and extracting a candidate battery 110 satisfying the battery requirement as a candidate for a presentation battery to be presented to the user from among the plurality of batteries 10B and 10C, based on the acquired battery information and battery requirement information. More specifically, the plurality of batteries 10 includes a first battery and a second battery, the battery information includes a battery element information on each of a plurality of battery elements 2 included in the first battery 10B and a battery element information on each of a plurality of battery elements 2 included in the second battery 10C, and the extracting includes determining whether it is possible to constitute the candidate battery 110 satisfying the battery requirement by a combination battery 112 including a part of the plurality of battery elements 2 included in the first battery 10B and a part of the plurality of battery elements 2 included in the second battery 10C, and when it is determined that it is possible to constitute the candidate battery 110 by the combination battery 112, extracting the combination battery 112 as the candidate battery 110.

The above embodiment can be combined as desired with one or more of the above modifications. The modifications can also be combined with one another.

According to the present invention, since the number of candidate of batteries to be used for a battery replacement increases, it is possible to present an optimal battery to a user.

Above, while the present invention has been described with reference to the preferred embodiments thereof, it will be understood, by those skilled in the art, that various changes and modifications may be made thereto without departing from the scope of the appended claims.

What is claimed is:

1. A battery management apparatus configured to manage a plurality of batteries including a used battery, comprising
an electronic control unit including a microprocessor and a memory connected to the microprocessor, wherein
the microprocessor is configured to perform:
acquiring an information on the plurality of batteries as a battery information;
acquiring a battery requirement information including a battery requirement required by a user; and
extracting a candidate battery satisfying the battery requirement as a candidate for a presentation battery to be presented to the user from among the plurality of batteries, based on the battery information and the battery requirement information, wherein
the plurality of batteries include a first battery and a second battery,
the battery information includes a battery element information on each of a plurality of battery elements included in the first battery and a battery element information on each of a plurality of battery elements included in the second battery, and
the microprocessor is configured to perform
the extracting including determining whether it is possible to constitute the candidate battery satisfying the battery requirement by a combination battery including a part of the plurality of battery elements included in the first battery and a part of the plurality of battery elements included in the second battery, and when it is determined that it is possible to constitute the candidate battery by the combination battery, extracting the combination battery as the candidate battery.

2. The battery management apparatus according to claim 1, wherein
the microprocessor is configured to perform
the extracting including further determining whether there is the candidate battery satisfying the battery requirement by a battery itself among the plurality of batteries, and when it is determined that there is not the candidate battery, determining whether it is possible to constitute the candidate battery by the combination battery.

3. The battery management apparatus according to claim 2, wherein
the microprocessor is configured to further perform
estimating a degree of degradation of the plurality of batteries at a predetermined time in a future, and
the extracting including extracting the candidate battery from among the plurality of batteries based on the degree of degradation estimated.

4. The battery management apparatus according to claim 3, wherein
the predetermined time is a time in the future at which using the presentation battery is started by the user,
the microprocessor is configured to further perform
selecting the presentation battery from the candidate battery before the predetermined time, and
the memory is configured to perform
memorizing an information on the presentation battery selected.

5. The battery management apparatus according to claim 4, wherein
the battery requirement includes a requirement for at least one of a battery performance and a battery price required by the user.

6. The battery management apparatus according to claim 1, wherein
the plurality of batteries include the first battery mounted on a first vehicle and the second battery mounted on a second vehicle.

7. A battery management method configured to manage a plurality of batteries including a used battery, comprising:
acquiring an information on the plurality of batteries as a battery information;
acquiring a battery requirement information including a battery requirement required by a user; and
extracting a candidate battery satisfying the battery requirement as a candidate for a presentation battery to be presented to the user from among the plurality of batteries, based on the battery information and the battery requirement information, wherein
the plurality of batteries include a first battery and a second battery,
the battery information includes a battery element information on each of a plurality of battery elements included in the first battery and a battery element information on each of a plurality of battery elements included in the second battery, and
the extracting includes determining whether it is possible to constitute the candidate battery satisfying the battery requirement by a combination battery including a part of the plurality of battery elements included in the first battery and a part of the plurality of battery elements included in the second battery, and when it is determined that it is possible to constitute the candidate battery by the combination battery, extracting the combination battery as the candidate battery.
